(19) United States
(12) Patent Application Publication
(10) Pub. No.: US 2004/0243440 A1
(43) Pub. Date: Dec. 2, 2004

(54) Statistical medical information providing apparatus

(75) Inventors: Kiyoyuki Narimatsu, Komaki-shi (JP); Toshihiko Ogura, Komaki-shi (JP)

Correspondence Address: OLIFF & BERRIDGE, PLC, P.O. BOX 19928, ALEXANDRIA, VA, 22320, US

(73) Assignee: COLIN CORPORATION, Komaki-shi (JP)

(21) Appl. No.: 10/729,901

(22) Filed: Dec. 9, 2003

(30) Foreign Application Priority Data
Dec. 20, 2002 (JP) 2002-370024

(51) Int. Cl. G06F 17/60; G06F 15/00; G06F 17/18; G06F 101/14

(52) U.S. Cl. 705/2; 702/179

(57) ABSTRACT

A plurality of physical information obtaining devices 10 and a statistical medical information providing apparatus 16 are connected to each other via a communication line 18, so that a set of measurement information including a set of physical information obtained by each of the physical information obtaining devices 10 from a patient, a set of device-related information that is related to the each obtaining device, and a set of patient-related information that is related to the patient, is transmitted to the providing apparatus 16. The statistical medical information providing apparatus 16 accumulates, one by one, the sets of measurement information transmitted from the physical information obtaining devices 10, in a measurement-information data base 34 of a memory device 32, and produces a set of statistical medical information based on the sets of measurement information stored in the data base 34. Since the data base 34 receives the sets of measurement information, one after another, from the obtaining devices 10 via the communication line 18, it can easily accumulate many sets of measurement information.

### BACKGROUND OF THE INVENTION

1. Field of the Invention

The present invention relates to a statistical medical information providing apparatus that statistically analyzes sets of physical information that have been measured by a plurality of physical-information obtaining devices and transmitted via a communication line, and provides the thus obtained statistical medical information via the communication line.

2. Related Art Statement

When a medical-equipment manufacturer develops a physical information obtaining device, the manufacturer may produce statistical medical information by statistically analyzing sets of physical information actually obtained by the obtaining device from patients. For example, an arteriosclerosis evaluating apparatus that is disclosed by Japanese Patent Application laid open under Publication No. 2001-190506 evaluates a degree of arteriosclerosis of a patient by comparing an actually measured pulse wave propagation velocity with a normal pulse wave propagation velocity that is determined based on a blood pressure of the patient according to a mathematical expression representing a relationship between blood pressure and pulse wave propagation velocity. The disclosed apparatus determines constants of the mathematical expression by statistically analyzing pulse wave propagation velocity values and blood pressure values obtained from a great number of patients.

In addition, in order to improve the developed physical information obtaining device, the manufacturer needs to statistically analyze the sets of physical information obtained by the obtaining device and thereby evaluate the reliability of the obtained sets of physical information. Moreover, when a doctor or a researcher evaluates the reliability of physical information obtained by a certain type of physical information obtaining device, he or she may want to statistically analyze the sets of physical information obtained by other physical information obtaining devices of the same type.

In order to obtain highly reliable statistical medical information, it is needed to construct a data base including a great number of sets of physical information. However, conventionally, a data base has been constructed by manually inputting sets of physical information, consuming much labor and time. The data base constructed in this manner may not be sufficiently new. In addition, the data base is constructed based on the sets of physical information obtained in only one hospital or a limited number of hospitals, and the number of those sets of physical information may be not sufficiently great. This is true with the case where sets of physical information obtained by each one of different types of physical information obtaining devices are statistically analyzed independent of sets of physical information obtained by the other types of physical information obtaining devices. Thus, statistical medical information that is produced by statistically analyzing sets of physical information obtained by each type of physical information obtaining devices may not be sufficiently reliable even if much labor and time may be consumed.

### SUMMARY OF THE INVENTION

It is therefore an object of the present invention to provide a statistical medical information providing apparatus that can easily produce and provide new and reliable statistical medical information by statistically analyzing sets of physical information based on sets of device-related information that represent respective types of physical information obtaining devices or respective methods in which the obtaining devices obtain respective sets of physical information.

The above object has been achieved by the present invention. According to the present invention, there is provided a statistical medical information providing apparatus, comprising a storing means for storing a plurality of sets of measurement information each of which includes (a) a set of physical information which is obtained by a corresponding one of a plurality of physical-information obtaining devices from a corresponding one of a plurality of living subjects and is supplied from the one physical-information obtaining device via a communication line and additionally includes (b) a set of device-related information that is related to the one physical-information obtaining device; a statistical medical information producing means for statistically analyzing the sets of physical information as part of the sets of measurement information stored by the storing means, based on the sets of device-related information, and thereby producing a set of statistical medical information; and an outputting means for transmitting, according to a request from a user's terminal device, the set of statistical medical information produced by the statistical medical information producing means, to the user's terminal device.

According to this invention, the statistical medical information producing means statistically analyzes the sets of physical information obtained by the physical information obtaining devices, based on the sets of device-related information that are related to the physical information obtaining devices, and thereby produces the set of statistical medical information. The outputting means transmits the produced set of statistical medical information to the user's terminal device. Thus, a medical-equipment manufacturer or a doctor, for example, can evaluate the reliability of the sets of physical information obtained by the physical information obtaining devices, based on the set of statistical medical information that has been produced based on the sets of device-related information. Since the sets of physical information used to produce the set of statistical medical information are supplied one after another from the physical information obtaining devices via the communication line, those sets of physical information are easily accumulated to a great number. Thus, one or more updated and reliable set of statistical medical information can be easily produced.

Here, preferably, the sets of device-related information represent respective types of the physical-information obtaining devices, and the statistical medical information producing means statistically analyzes the sets of physical information obtained by each type of physical-information obtaining devices, and thereby produces a set of statistical medical information for the each type of physical-information obtaining devices. According to this feature, the reliability of each type of physical information obtaining devices can be evaluated with high reliability and accordingly the manufacturer who manufactures that type of obtaining devices can improve, based on the reliable statistical medical information, those obtaining devices and thereby improve the reliability of physical information obtaining operations of the same. In addition, the doctor who makes diagnoses based on the sets of physical information obtained by that type of obtaining devices can evaluate, based on the reliable statistical medical information, the reliability of the sets of physical information obtained by that type of obtaining devices.

Here, preferably, the sets of device-related information represent respective physical-information obtaining methods carried out by the physical-information obtaining devices, and the statistical medical information producing means statistically analyzes the sets of physical information obtained by each of the physical-information obtaining methods, and thereby produces a set of statistical medical information for the each physical-information obtaining method. According to this feature, the reliability of each of the physical information obtaining methods carried out by the obtaining devices can be evaluated with high reliability. Thus, for example, when a new obtaining method different from a conventional obtaining method is used to obtain a conventionally obtained sort of physical information, the reliability of the new obtaining method can be evaluated.

Also, preferably, the statistical medical information producing means statistically analyzes the sets of physical information based on an instruction signal that is transmitted from the user's terminal device and represents a statistical-analysis manner in which the user's terminal device instructs the statistical medical information producing means to statistically analyze the sets of physical information. According to this feature, each user can obtain one or more desirable sets of statistical medical information.

### BRIEF DESCRIPTION OF THE DRAWINGS

The above and optional objects, features, and advantages of the present invention will be better understood by reading the following detailed description of the preferred embodiments of the invention when considered in conjunction with the accompanying drawings, in which:

FIG. 1 is a view showing a construction of a medical information providing system including a statistical medical information providing apparatus to which the present invention is applied;

FIG. 2 is a diagrammatic view for explaining essential control functions of a CPU (central processing unit) of the statistical medical information providing apparatus shown in FIG. 1; and

FIG. 3 is a flow chart for explaining the essential control functions of the CPU of the statistical medical information providing apparatus.

### DETAILED DESCRIPTION OF PREFERRED EMBODIMENTS

Hereinafter, there will be described a preferred embodiment of the present invention in detail by reference to the drawings.

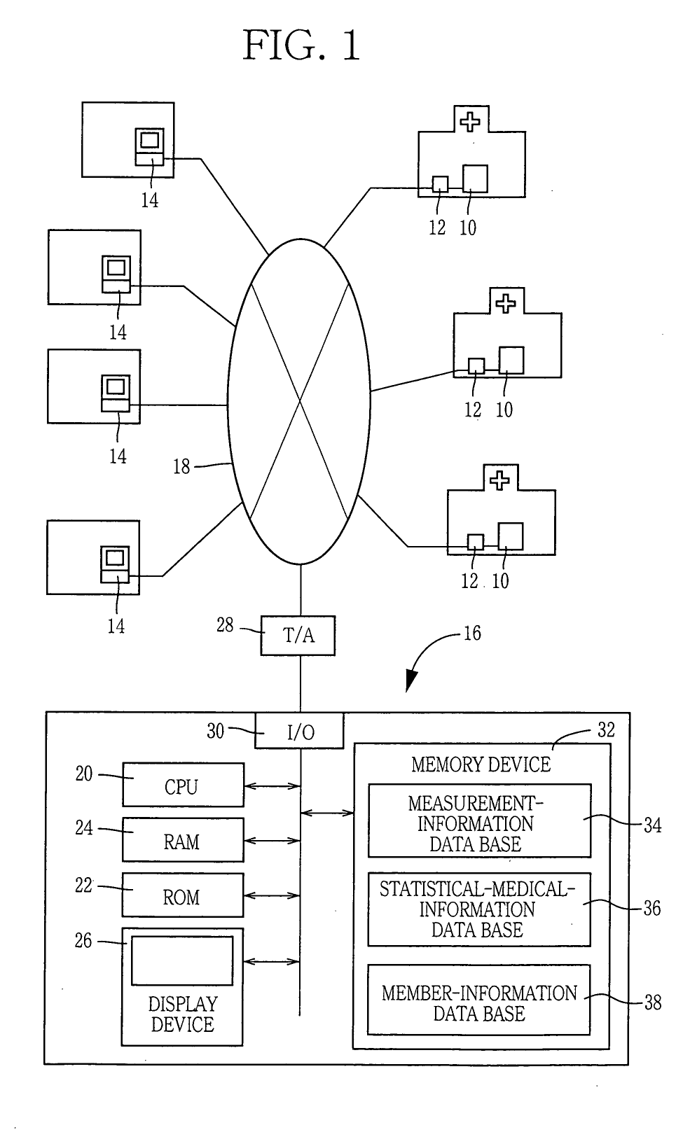

FIG. 1 shows a construction of a medical information providing system including a statistical medical information providing apparatus 16 as the embodiment of the present invention. The medical information providing system shown in FIG. 1 includes a plurality of physical information obtaining devices 10 that are disposed in, e.g., a plurality of hospitals, respectively, and obtain a plurality of sets of physical information from a plurality of patients as a plurality of living subjects, respectively; a plurality of communication devices 12 that are connected to the physical information obtaining devices 10, respectively, and transmit the respective sets of physical information obtained by the physical information obtaining devices 10; a plurality of member's terminal devices 14 that are operated by a plurality of members, respectively; the statistical medical information providing apparatus 16; and a communication line 18.

Each of the physical information obtaining devices 10 obtains, from a patient, a set of physical information representing at least one physical parameter selected from, e.g., blood pressure, BP, body weight, W, stature, T, body fat percentage, heart rate, HR, electrocardiogram, body temperature, pulse wave propagation velocity, PWV, and ankle-and-brachium blood-pressure index, ABI. Each physical information obtaining device 10 includes an input device, not shown, that is operable by an operator for inputting a set of patient-related information representing the patient's name, address (i.e., living area in which the patient lives), age, sex, clinical history, stature, and body weight. The set of patient-related information may additionally include at least one set of physical information that has been obtained by a physical information obtaining device different from the each physical information obtaining device 10. Each physical information obtaining device 10 outputs, to an output device, not shown, the obtained set of physical information together with the set of patient-related information inputted through the input device. When those sets of information are outputted to the output device, a doctor can make a diagnosis based on the thus outputted sets of information. Each physical information obtaining device 10 additionally includes a memory device, not shown, that stores the obtained set of physical information and the set of patient-related information inputted through the input device.

Each time each physical information obtaining device 10 obtains a set of physical information from a patient, the each obtaining device 10 outputs, to the corresponding communication device 12, a set of measurement information including the obtained set of physical information (i.e., the sort of the obtained information and the obtained or measured value), an inputted set of patient-related information, and a pre-stored set of device-related information that is related to the each obtaining device 10. The pre-stored set of device-related information represents a specific type of the each obtaining device 10, and a specific obtaining method in which the each obtaining device 10 obtains a set of physical information. For example, when a blood pressure is obtained or measured as the set of physical information, the obtaining or measuring method may be first selected from invasive and non-invasive methods in a large class of obtaining methods, then selected from cuff-using and tonometry methods in a subclass of, e.g., non-invasive methods, and additionally selected from oscillometric and Korotkoff-sound methods in a smaller class of, e.g., cuff-using methods. Thus, for each one of the different types of the physical information obtaining devices 10, and/or for each one of the different obtaining methods in which the obtaining devices 10 obtain sets of physical information, the statistical medical information providing apparatus 16 can perform a statistical analysis on the sets of physical information.

Each of the communication devices 12 includes a modem, a terminal adaptor, a router, etc. and thereby has the function of transmitting the set of measurement information that has been supplied from the corresponding physical information obtaining device 10, to the statistical medical information providing apparatus 16, via the communication line 18.

Each of the member's terminal devices 14 functioning as user's terminal devices is provided by a computer having a communication function, is disposed in, e.g., a hospital or a medical-equipment manufacturer, and is operated by a corresponding one of a plurality of members who are allowed to make access to the present medical information providing system.

When each of the allowed members wants to obtain a specific sort of statistical medical information, the member operates the corresponding member's terminal device 14 to transmit, to the statistical medical information providing apparatus 16 via the communication line 18, a statistical medical information request signal to request the specific sort of statistical medical information. In addition, when the member wants to instruct the statistical medical information providing apparatus 16 to perform a specific sort of statistical analysis, the member operates the member's terminal device 14 to transmit a statistical analysis instruction signal to instruct the providing device 16 to perform a statistical analysis that is specific with respect to method, object, scope, etc. The statistical-analysis method that can be instructed by the statistical analysis instruction signal may be selected from arithmetic average, standard deviation, variance, deviation, frequency distribution, or other generally known statistical analysis techniques. In a particular case where a plurality of sorts of physical parameters are statistically analyzed, correlation coefficient or multiple correlation coefficient may be selected. In addition, the statistical-analysis object that can be instructed by the instruction signal means the sort or sorts of physical parameter or parameters that is or are to be statistically analyzed; and the statistical-analysis scope that can be instructed by the instruction signal may be selected from, e.g., the patient's sex, age, living area, etc. that are represented by each set of patient-related information.

The statistical medical information providing apparatus 16 is provided by a high-speed and high-capacity computer including a CPU (central processing unit) 20; a ROM (read only memory) 22 that stores control programs; a RAM (random access memory) 24 that functions as a temporary-storage device; a display device 26; a terminal adaptor 28; an input-and-output interface 30 that is connected to the communication line 18 via the terminal adaptor 28; and a memory device 32.

The memory device 32 is provided by, e.g., a hard disc, and includes a measurement-information data base 34 that stores a plurality of sets of measurement information that are transmitted from the physical-information obtaining devices 10 via the respective communication devices 12; a statistical-medical-information data base 36 that stores a plurality of sets of statistical medical information that are obtained by statistically analyzing the sets of measurement information stored in the measurement-information data base 34; and a member-information data base 38 that stores, for each of the members, a set of member information representing a name, an identification code, etc. of the each member.

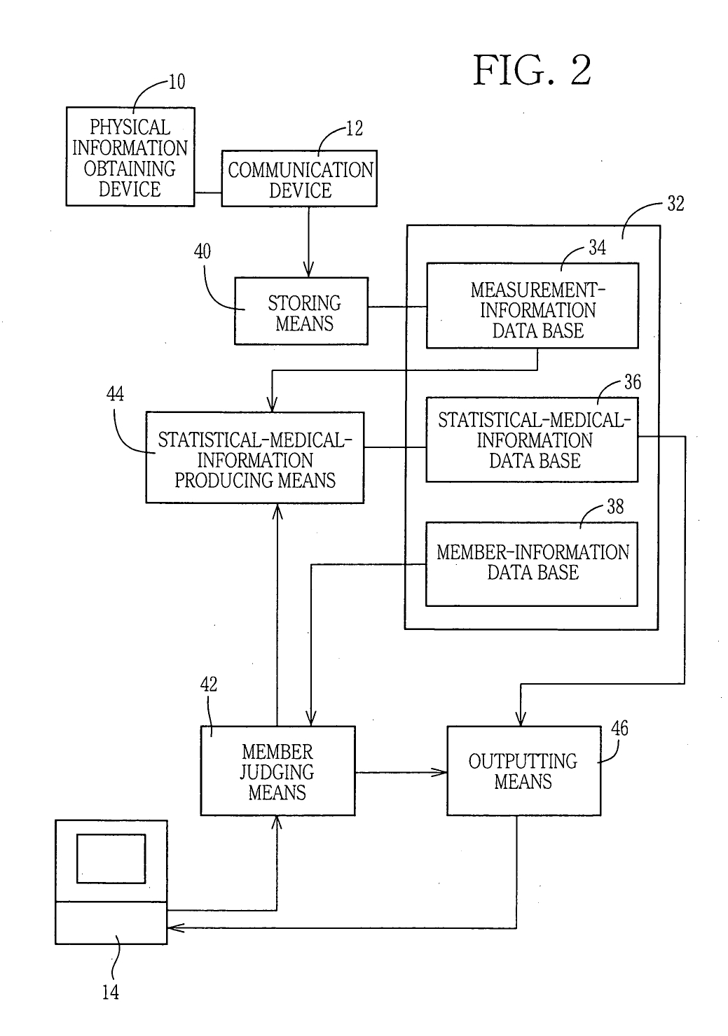

FIG. 2 is a diagrammatic view for explaining essential control functions of the CPU 20 of the statistical medical information providing apparatus 16. A storing means 40 stores, in the measurement-information data base 34 of the memory device 32, the sets of measurement information transmitted from the physical-information obtaining devices 10 via the respective communication devices 12.

A member judging means 42 receives a name and an identification code that are supplied from each of the member's terminal devices 14 that is making access to the statistical medical information providing apparatus 16, checks the received name and identification code against the names and identification codes stored in the member-information data base 38, and judges whether a person who is making access to the providing apparatus 16 is a member registered on the data base 38. If the member judging means 42 judges that the person who is making access to the providing apparatus 16 is a registered member, then the member judging means 42 identifies of which sort the signal transmitted from the member's terminal device 14 is. If the signal is a statistical analysis instruction signal, then the member judging means 42 supplies the signal to a statistical medical information producing means 44; and if the signal is a statistical medical information request signal, then the member judging means 42 supplies the signal to an outputting means 46.

The statistical medical information producing means 44 statistically analyzes the sets of physical information as part of the sets of measurement information stored in the measurement-information data base 34, based on the sets of device-related information as another part of the sets of measurement information, and thereby obtains a set of statistical medical information. As explained above, the sets of physical information stored in the measurement-information data base 34 represent a plurality of sorts of physical parameters including, e.g., blood pressure BP and pulse-wave propagation velocity PWV; and the sets of device-related information represent a plurality of types of the physical-information obtaining devices and a plurality of sorts of obtaining methods. Thus, it is possible to obtain a plurality of sorts of statistical medical information. However, the statistical medical information producing means 44 obtains a pre-selected sort of statistical medical information by statistically analyzing, using a pre-selected statistical analysis method, the sets of physical information that correspond to pre-selected object and scope. Alternatively, the statistical medical information producing means 44 obtains a sort of statistical medical information by statistically analyzing, using the statistical analysis method represented by the statistical analysis instruction signal supplied from the member's terminal device 14, the sets of physical information that correspond to the object and scope represented by the statistical analysis instruction signal. In addition, the statistical medical information producing means 44 obtains a set of statistical medical information by statistically analyzing the sets of physical information that correspond to each one of the types of the physical information obtaining devices 10 and/or each one of the obtaining methods in which the obtaining devices 10 obtain the sets of physical information.

The outputting means 46 selects, when the statistical medical information request signal supplied from each of the member's terminal devices 14 is judged by the member judging means 42 as being a request signal from a registered member, and is supplied to the outputting means 46, a set of statistical medical information requested by the request signal, from the sets of statistical medical information stored in the statistical medical information data base 36, and transmits the thus selected set of statistical medical information to the member's terminal device 14 that has supplied the request signal.

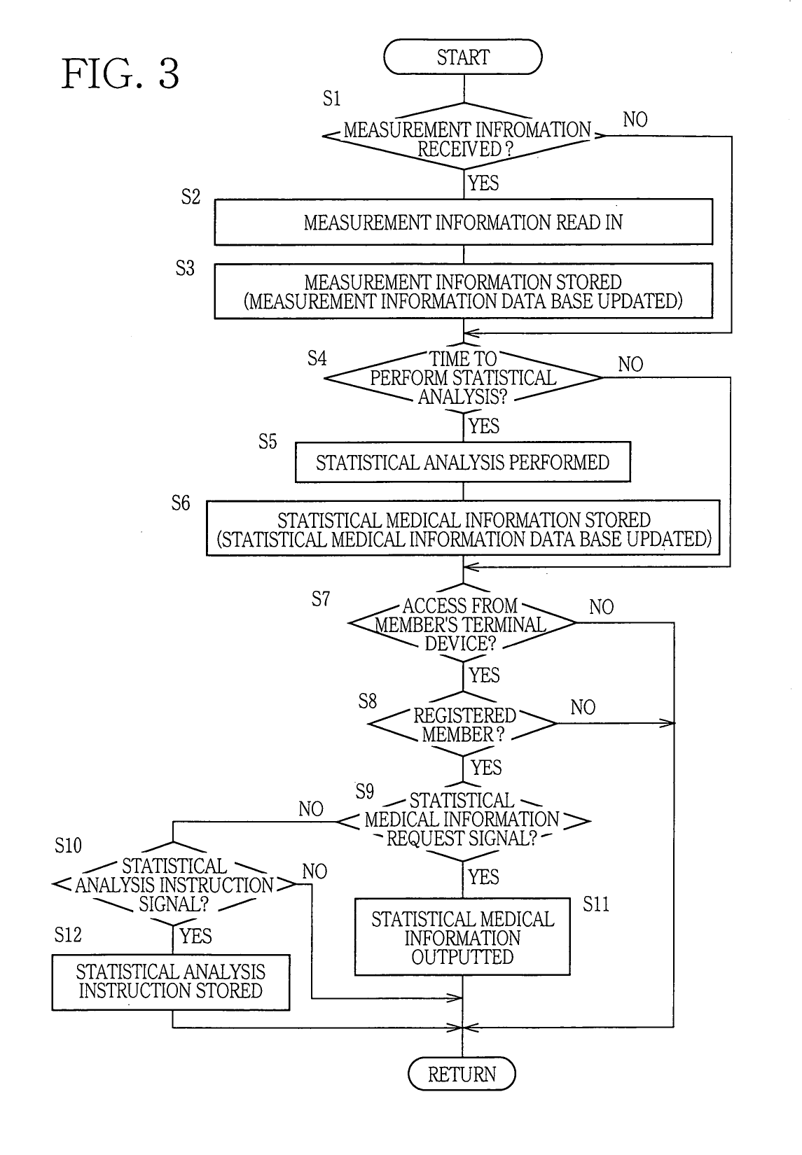

FIG. 3 is a flow chart for explaining the essential control functions of the CPU 20 of the statistical medical information providing apparatus 16. This flow chart is periodically carried out at a pre-set short period.

At Step S1 (hereinafter, “Step” is omitted), the CPU judges whether the statistical medical information providing apparatus 16 has received a set of measurement information transmitted from any one of the physical information obtaining devices 10. If a negative judgment is made at S1, the control of the CPU jumps to S4, described later.

On the other hand, if a positive judgment is made at S1, the control goes to S2 and S3 corresponding to the storing means 40. More specifically described, first at S2, the CPU reads in the received set of measurement information and, then at S3, the CPU stores (or accumulates) the read-in set of measurement information in the measurement-information data base 34 of the memory device 32, thereby updating the measurement-information data base 34.

If a negative judgment is made at S1, or after S3 is carried out, the control goes to S4 to judge whether it is now a pre-set time to perform a statistical analysis. The pre-set time may be a time when a pre-set time period has passed since the last statistical analysis was performed; a time when the measurement-information data base 34 has been updated a pre-set number of times; a time when the statistical medical information providing apparatus 16 has just received a statistical analysis instruction signal transmitted from any one of the member's terminal devices 14; or any one of at least two times selected from those three times.

If a negative judgment is made at S4, the control jumps to S7, described later. On the other hand, if a positive judgment is made at S4, the control goes to S5 to statistically analyze the sets of measurement information stored in the measurement-information data base 34, according to the pre-set statistical-analysis method, object, and scope, or according to the statistical-analysis method, object, and scope represented by the statistical analysis instruction signal sent from any one of the member's terminal devices 14, and thereby produce one or more sets of statistical medical information. Then, at S6, the CPU stores the set or sets of statistical medical information produced at S5, in the statistical medical information data base 36 of the memory device 32, thereby updating the statistical medical information data base 36.

If a negative judgment is made at S4, or after S6 is carried out, the control of the CPU goes to S7 through S10 corresponding to the member judging means 42. First, at S7, the CPU judges whether any one of the member's terminal devices 14 is making access to the statistical medical information providing apparatus 16. If a negative judgment is made at S7, the current control cycle according to this routine is ended. On the other hand, if a positive judgment is made at S7, the CPU checks the member's name and identification code transmitted from the one member's terminal device 14, against the members' names and identification codes stored in the member information data base 38 of the memory device 32, and thereby judges whether any one of the registered members is making access.

If a negative judgment is made at S8, the current control cycle according to this routine is ended. On the other hand, if a positive judgment is made at S8, the control of the CPU goes to S9 to judge whether the statistical medical information providing apparatus 16 has received a statistical medical information request signal from the one member's terminal device 14 that is making access to the apparatus 16. If a negative judgment is made at S9, the control goes to S10 to judge whether the apparatus 16 has received a statistical analysis instruction signal from the one member's terminal device 14 that is making access to the apparatus 16.

If a positive judgment is made at S9, that is, if the statistical medical information providing apparatus 16 has received the statistical medical information request signal, the control goes to S11 corresponding to the outputting means 46. At S11, the CPU selects, from the sets of statistical medical information stored in the statistical medical information data base 36, one or more sets of statistical medical information requested by the received request signal, and outputs the selected set or sets of statistical medical information, to the one member's terminal device 14 that has transmitted the request signal.

If a negative judgment is made at S10, the current control cycle according to this routine is ended. On the other hand, if a positive judgment is made at S10, that is, if the statistical medical information providing apparatus 16 has received the statistical analysis instruction signal, the control of the CPU goes to S12 to store the statistical-analysis manner (i.e., the statistical-analysis method, object, and scope) represented by the instruction signal, in a prescribed memory area of the memory device 32. In the present flow chart, S12 and S4 through S6 correspond to the statistical medical information producing means 44.

In the illustrated embodiment, the statistical medical information producing means 44 (S4 through S6, S12) statistically analyzes the sets of physical information obtained by the physical information obtaining devices 10, based on the sets of device-related information that represent the respective types of the physical information obtaining devices 10 and the respective physical-information obtaining methods of the same 10, and thereby produces one or more sets of statistical medical information. The outputting means 46 (S11) transmits the produced set or sets of statistical medical information to one of the member's terminal devices 14 that requests the information. Thus, each registered member such as a medical-equipment manufacturer or a doctor can evaluate the reliability of the sets of physical information obtained by the physical information obtaining devices 10, based on the set or sets of statistical medical information that has or have been produced based on the sets of device-related information. Since the sets of physical information used to produce the set or sets of statistical medical information are supplied one after another from the physical information obtaining devices 10 via the communication line 18, those sets of physical information are easily accumulated to a great number. Therefore, one or more updated and reliable sets of statistical medical information can be easily produced.

Also, in the illustrated embodiment, the sets of device-related information represent the respective types of the physical information obtaining devices 10, and the statistical medical information producing means 44 (S4 through S6, S12) produces one or more sets of statistical medical information by statistically analyzing the sets of physical information obtained by each type of physical information obtaining devices 10. Therefore, the reliability of each type of obtaining devices 10 can be evaluated with high reliability and accordingly the manufacture who manufactures that type of obtaining devices 10 can improve, based on the reliable statistical medical information, those obtaining devices 10 and thereby improve the reliability of measurement of the same 10. In addition, the doctor who makes diagnoses based on the sets of physical information obtained by that type of obtaining devices 10 can evaluate, based on the reliable statistical medical information, the reliability of the sets of physical information obtained by that type of obtaining devices 10.

Also, in the illustrated embodiment, the sets of device-related information represent the respective physical information obtaining methods performed by the physical information obtaining devices 10, and the statistical medical information producing means 44 (S4 through S6, S12) produces one or more sets of statistical medical information by statistically analyzing the sets of physical information obtained by each of the physical information obtaining methods. Therefore, the reliability of each of the physical information obtaining methods performed by the obtaining devices 10 can be evaluated with high reliability. Thus, for example, when a new obtaining method different from a conventional obtaining method is used to obtain a conventionally obtained sort of physical information, the reliability of the new obtaining method can be evaluated.

Also, in the illustrated embodiment, the statistical medical information producing means 44 (S4 through S6, S12) performs the statistical analysis based on the statistical-analysis manner (e.g., the statistical-analysis method, object, and scope) represented by the statistical analysis instruction signal transmitted from any one of the member's terminal devices 14. Thus, each of the registered members can obtain one or more desirable sets of statistical medical information.

While the present invention has been described in its embodiment by reference to the drawings, it is to be understood that the invention may otherwise be embodied.

For example, in the illustrated embodiment, the sets of device-related information that are transmitted from the physical information obtaining devices 10 represent not only the respective types of the physical information obtaining devices 10 but also the respective physical information obtaining methods of the same 10. However, it is possible to store, in the memory device 32 of the statistical medical information providing device 16, data representing a relationship between the respective types of the physical information obtaining devices 10 and respective specifications (e.g., the respective physical information obtaining methods) of those types. In the latter case, the sets of device-related information transmitted from the physical information obtaining devices 10 may represent only the respective types of the obtaining devices 10.

In addition, in the illustrated embodiment, each time each of the physical information obtaining devices 10 obtains one set of physical information, the each obtaining device 10 transmits one set of measurement information including the one set of physical information. However, each obtaining device 10 may be so modified as to periodically transmit one or more sets of measurement information.

In addition, in the illustrated embodiment, only the registered members are allowed to obtain the set or sets of statistical medical information. However, it is possible to allow a person who is not registered as a member, to obtain one or more sets of statistical medical information.

While the present invention has been described in its embodiments in detail by reference to the drawings, it may be understood that the present invention is by no means limited to the details of the embodiments but may be embodied with various changes and improvements that may occur to a person skilled in the art.

What is claimed is:

1. A statistical medical information providing apparatus, comprising:
a storing means for storing a plurality of sets of measurement information each of which includes (a) a set of physical information which is obtained by a corresponding one of a plurality of physical-information obtaining devices from a corresponding one of a plurality of living subjects and is supplied from said one physical-information obtaining device via a communication line and additionally includes (b) a set of device-related information that is related to said one physical-information obtaining device;
a statistical medical information producing means for statistically analyzing the sets of physical information as part of the sets of measurement information stored by the storing means, based on the sets of device-related information, and thereby producing a set of statistical medical information; and
an outputting means for transmitting, according to a request from a user's terminal device, the set of statistical medical information produced by the statistical medical information producing means, to the user's terminal device.

2. The statistical medical information providing apparatus according to claim 1, wherein the sets of device-related information represent respective types of the physical-information obtaining devices, and wherein the statistical medical information producing means statistically analyzes the sets of physical information obtained by each type of physical-information obtaining devices, and thereby produces a set of statistical medical information for said each type of physical-information obtaining devices.

3. The statistical medical information providing apparatus according to claim 1, wherein the sets of device-related information represent respective physical-information obtaining methods carried out by the physical-information obtaining devices, and wherein the statistical medical information producing means statistically analyzes the sets of physical information obtained by each of the physical-information obtaining methods, and thereby produces a set of statistical medical information for said each physical-information obtaining method.

4. The statistical medical information providing apparatus according to claim 1, wherein the statistical medical information producing means statistically analyzes the sets of physical information based on an instruction signal that is transmitted from the user's terminal device and represents a statistical-analysis manner in which the user's terminal device instructs the statistical medical information producing means to statistically analyze the sets of physical information.

5. A statistical medical information providing apparatus, comprising:
a storing device which stores a plurality of measurement information each of which includes (a) a set of physical information which is obtained by a corresponding one of a plurality of physical-information obtaining devices from a corresponding one of a plurality of living subjects and is supplied from said one physical-information obtaining device via a communication line and additionally includes (b) a set of device-related information that is related to said one physical-information obtaining device;
a statistical medical information producing device which statistically analyzes the sets of physical information as part of the sets of measurement information stored by the storing device, based on the sets of device-related information, and thereby produces a set of statistical medical information; and
an outputting device which transmits, according to a request from a user's terminal device, the set of statistical medical information produced by the statistical medical information producing device, to the user's terminal device.
